(19) United States
(12) Patent Application Publication
(10) Pub. No.: US 2023/0236529 A1
(43) Pub. Date: Jul. 27, 2023

(54) CONDUCTIVE MEMBER, TRANSFER DEVICE, PROCESS CARTRIDGE, AND IMAGE FORMING APPARATUS

(71) Applicant: FUJIFILM Business Innovation Corp., Tokyo (JP)

(72) Inventors: Shogo HAYASHI, Kanagawa (JP); Satoya SUGIURA, Kanagawa (JP)

(73) Assignee: FUJIFILM Business Innovation Corp., Tokyo (JP)

(21) Appl. No.: 18/151,390

(22) Filed: Jan. 6, 2023

(30) Foreign Application Priority Data
Jan. 24, 2022 (JP) 2022-008890

(51) Int. Cl. G03G 15/16; G03G 21/18

(52) U.S. Cl. CPC G03G 15/162; G03G 21/1814

(57) ABSTRACT

A conductive member includes: a conductive base material; and a silica glass layer disposed on an outermost surface on an outer peripheral surface of the conductive base material.

### CROSS-REFERENCE TO RELATED APPLICATIONS

This application is based on and claims priority under 35 USC 119 from Japanese Patent Application No. 2022-008890 filed on Jan. 24, 2022.

### BACKGROUND

### (i) Technical Field

The present invention relates to a conductive member, a transfer device, a process cartridge, and an image forming apparatus.

### (ii) Related Art

JP6033059B discloses “An intermediate transfer body including a base material layer in which a conductive agent is dispersed, and a surface layer, wherein the surface layer contains a silicon oxide film containing carbon, the silicon oxide film has a bending vibration peak of Si—CH₃ in an infrared absorption spectrum, a proportion of the number of carbon atoms bonded to silicon atoms to the total number of carbon atoms, silicon atoms, and oxygen atoms in the silicon oxide film is 40 at % or more and 72 at % or less, and a ratio of the number of oxygen atoms bonded to silicon atoms to the number of silicon atoms is 0.85 or more and 1.2 or less”.

JP2000-221799A discloses “an image forming apparatus that transfers an image formed on a first image carrying body onto an intermediate transfer body and then further transfers the image onto a second image carrying body, wherein the intermediate transfer body has a silica coating layer”.

Conventionally, when a conductive member having a resin layer containing fluorine-containing resin particles (e.g., perfluoroalkyl resin particles) as an outermost surface layer is used as, for example, a transfer member or the like in an image forming apparatus, cracks may be generated in the outermost surface layer. As a result, for example, toner remains on the cracks then collapses and stretches, which tends to generate streak-like image defects on the back surface when single-sided printing is performed.

### SUMMARY

Aspects of non-limiting embodiments of the present disclosure relate to a conductive member that has excellent cleaning properties and inhibits streak-like image defects caused by generation of cracks when the conductive member is mounted on an image forming apparatus, as compared with a conductive member including a resin layer containing fluorine-containing resin particles (e.g., perfluoroalkyl resin particles) as an outermost surface layer, or a conductive member including an inorganic layer having a half width of a diffraction peak derived from silicon dioxide of less than 5° as obtained by a powder X-ray diffraction method as an outermost surface layer.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a conductive member including: a conductive base material; and a silica glass layer disposed on an outermost surface on an outer peripheral surface of the conductive base material.

### BRIEF DESCRIPTION OF THE DRAWINGS

FIG. 1 is a schematic perspective view illustrating an example of a conductive member according to an exemplary embodiment.

FIG. 2 is a schematic sectional view illustrating an example of the conductive member according to the exemplary embodiment, illustrated in cross section taken along line A-A in FIG. 1.

FIG. 3 is a schematic configuration diagram illustrating an example of an image forming apparatus according to the exemplary embodiment.

FIG. 4 is a schematic configuration diagram illustrating another example of the image forming apparatus according to the exemplary embodiment.

FIG. 5 is a schematic configuration diagram illustrating a periphery of a secondary transfer part in another example of the image forming apparatus according to the embodiment.

### DETAILED DESCRIPTION

Hereinafter, exemplary embodiments of the present invention will be described.

In the present specification, when there are a plurality of substances corresponding to a component in the composition, the amount of the component refers to the total amount of the plurality of substances unless otherwise specified.

In the present specification, the term “conductive” means that the volume resistivity in a normal-temperature and normal-humidity environment (22° C. and 55% RH environment) is 10¹⁴ Ω·cm or less.

<Conductive Member>

A conductive member according to a first exemplary embodiment includes a conductive base material and a silica glass layer disposed on an outermost surface on an outer peripheral surface of the conductive base material.

A conductive member according to a second exemplary embodiment includes a conductive base material and an inorganic layer disposed on an outermost surface on an outer peripheral surface of the conductive base material, wherein the inorganic layer has a half width of a diffraction peak derived from silicon dioxide of 5° or more as obtained by a powder X-ray diffraction method.

Each of the conductive members according to the first and second exemplary embodiments with the above-described configuration has excellent cleaning properties and inhibits streak-like image defects caused by generation of cracks when the conductive member is mounted on an image forming apparatus.

Conventionally, a conductive member having a resin layer containing fluorine-containing resin particles (e.g., perfluoroalkyl resin particles) as an outermost surface layer has been developed. However, the resin layer provided as the outermost layer of the conductive member tends to be brittle because it is made of resin which deteriorates over time because of application of an electric field or the like. The resin layer tends to be brittle also because the hardness is set to be high. Thus, the outermost surface layer may have cracks because of pressure contact in cleaning toner residues remaining on the outermost surface layer with a cleaning blade, the nip load of a transfer part, and the like. This may cause, for example, the toner to remain in the cracks, then collapse and stretch (hereinafter also referred to as “filming”). When such a conductive member on which filming has occurred is used as, for example, a transfer member in an image forming apparatus, streak-like image defects tend to occur (in particular, streak-like image defects tend to occur on the back surface of a recording medium on which single-sided printing has been performed).

Each of the conductive members according to the first and second exemplary embodiments has the above-described configuration, and thus has excellent cleaning properties and inhibits streak-like image defects caused by generation of cracks when the conductive member is mounted on an image forming apparatus. The reason for this is not clear but may be assumed as follows.

In the conductive member according to the first exemplary embodiment, the layer disposed on the outermost surface is a silica glass layer. In the conductive member according to the second exemplary embodiment, a half width of a diffraction peak derived from silicon dioxide of the inorganic layer disposed on the outermost surface is 5° or more as obtained by a powder X-ray diffraction method. That is, the inorganic layer is not in a crystalline state but in an amorphous state. Thus, the conductive member has high hardness and toughness, and the outermost surface layer is less likely to be cracked by the pressing of the cleaning blade in the cleaning of remaining toner or the nip load of the transfer part, as compared with the case where the surface layer is made of resin. Thus, filming caused by the cracks is inhibited, and it is considered that streak-like image defects on the back surface is inhibited when single-side printing is performed using the conductive member mounted on an image forming apparatus.

A conductive member according to an exemplary embodiment will be described with reference to the drawings.

FIG. 1 is a schematic perspective view illustrating an example of the conductive member according to the exemplary embodiment.

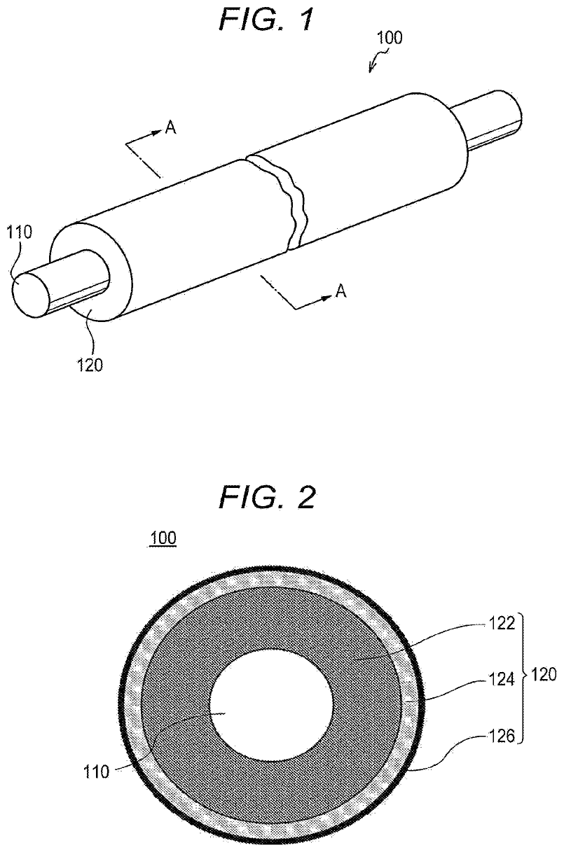

FIG. 2 is a sectional view taken along the line A-A in FIG. 1 of the conductive member illustrated in FIG. 1.

As illustrated in FIG. 1, a conductive member 100 is a roller member including a cylindrical conductive base material 110 and a layered material 120 disposed on an outer peripheral surface of the conductive base material 110, the layered material 120 including an elastic layer 122, an intermediate layer 124, and an inorganic layer 126. The conductive member according to the exemplary embodiment may be a belt member.

In the first exemplary embodiment, the inorganic layer 126 is an inorganic layer in which the half width of a diffraction peak derived from silicon dioxide is 5° or more as obtained by a powder X-ray diffraction method.

In the second exemplary embodiment, the inorganic layer 126 is a silica glass layer.

As illustrated in FIG. 2, the layer configuration of the conductive member 100 includes the elastic layer 122 disposed on the outer peripheral surface of the cylindrical conductive base material 110, the intermediate layer 124 disposed on the outer peripheral surface of the elastic layer 122, and the inorganic layer 126 disposed on the outer peripheral surface of the intermediate layer 124.

The conductive member according to the exemplary embodiment is not limited to the configuration illustrated in FIGS. 1 and 2, and for example, an adhesive layer may be appropriately provided between the conductive base material layer 110 and the elastic layer 122, between the elastic layer 122 and the intermediate layer 124, and between the intermediate layer 124 and the inorganic layer 126.

Hereinafter, the conductive member 100 according to the exemplary embodiment will be described in detail. The references are omitted in the description.

(Inorganic Layer)

The inorganic layer is disposed on the outermost surface on the outer peripheral surface of the conductive base material.

One layer or two or more layers may be provided as the inorganic layer.

When the conductive member is provided with a plurality of inorganic layers in the second exemplary embodiment, the inorganic layer disposed on the outermost surface on the outer peripheral surface of the conductive base material has a half width of a diffraction peak derived from silicon dioxide of 5° or more as obtained by a powder X-ray diffraction method.

When the conductive member is provided with a plurality of inorganic layers in the first exemplary embodiment, the inorganic layer disposed on the outermost surface on the outer peripheral surface of the conductive base material is a silica glass layer.

As the inorganic layer according to the first exemplary embodiment, a silica glass layer is applied.

In the silica glass layer, the half width of the diffraction peak derived from silicon dioxide is preferably 5° or more, more preferably 5° or more and 15° or less, and still more preferably 5° or more and 10° or less as obtained by a powder X-ray diffraction method.

In the inorganic layer according to the second exemplary embodiment, the half width of the diffraction peak derived from silicon dioxide is 5° or more, preferably 5° or more and 15° or less, and more preferably 5° or more and 10° or less as obtained by a powder X-ray diffraction method.

When the inorganic layer including the silica glass layer has a half width of the diffraction peak of 5° or more, the inorganic layer is more likely to have an amorphous form, resulting in having higher hardness and toughness. When the half width of the diffraction peak is 15° or less (more preferably 10° or less), the toughness is inhibited from becoming excessively high.

The half width of the diffraction peak derived from silicon dioxide as obtained by the powder X-ray diffraction method is obtained as follows.

A thin film X-ray diffraction spectrum is obtained from a measurement of thin film X-ray diffraction by X-ray irradiation with X, =1.5405 Å at a Cu target using an X-ray diffractometer (“D8 DISCOVER”, manufactured by Bruker AXS K.K.). In the obtained thin film X-ray diffraction spectrum, a diffraction peak observed in the range of 10° or more and 35° or less at the Bragg angle (2θ±0.2°) is assigned as a diffraction peak derived from silicon dioxide.

A linear distance from a point C, at which the maximum peak value P_{MAX} of the diffraction peak derived from silicon dioxide and the baseline B perpendicularly intersect, to the maximum peak value P_{MAX} is defined as a “height of the diffraction peak derived from silicon dioxide”. A peak width (full width at half maximum) at a height of ½ of the obtained height is set as a half width.

A method for setting the half width of the diffraction peak derived from silicon dioxide of the inorganic layer within the above range as obtained by a powder X-ray diffraction method is not limited. Examples thereof include a method of using a silica glass layer described later as the inorganic layer and a method of adjusting a heating time, a heating temperature, and the like at the time of forming the silica glass layer or the inorganic layer.

The inorganic layer is not limited as long as the half width of the diffraction peak derived from silicon dioxide obtained by a powder X-ray diffraction method is within the above range. Examples thereof include a layer of a reaction product such as water glass (including an aqueous solution of a sodium salt of metasilicate, sodium silicate, or the like) in addition to the silica glass layer described below.

(Silica Glass Layer)

The silica glass layer is disposed on the outermost surface on the outer peripheral surface of the conductive base material.

The silica glass layer may be either one or more than one layer.

The conductive member according to the first exemplary embodiment includes a silica glass layer.

The conductive member according to the second exemplary embodiment preferably includes a silica glass layer as the inorganic layer. When the conductive member according to the second exemplary embodiment includes a silica glass layer as the inorganic layer, the half width of the diffraction peak derived from silicon dioxide of the inorganic layer is likely to be adjusted to 5° or more as obtained by a powder X-ray diffraction method. That is, since the inorganic layer is likely to have an amorphous form, the conductive member is likely to have high hardness and toughness as compared with the case where the surface layer is made of resin. As a result, it is considered that the outermost surface layer is less likely to be cracked by the pressing of the cleaning blade in the cleaning of remaining toner or the nip load of the transfer part.

The silica glass layer refers to a layer of silicon dioxide that does not have a clear crystal state (that is, in an amorphous state) in the diffraction spectrum obtained by a powder X-ray diffraction method described above.

The silica glass layer is not limited, but is preferably, for example, a layer of a reaction product of a tetraalkoxysilane. When the silica glass layer is a layer of a reaction product of a tetraalkoxysilane, the half width of the diffraction peak derived from silicon dioxide obtained by a powder X-ray diffraction method is likely to be adjusted to 5° or more, and the silica glass layer is more likely to have an amorphous form.

Tetraalkoxysilane

The tetraalkoxysilane is a compound in which four alkoxy groups are bonded to a Si atom and is represented by the following general formula (2).

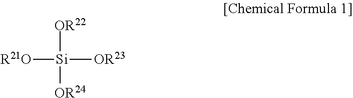

In the general formula (2), R²¹, R²², R²³, and R²⁴ each independently represent a substituted or unsubstituted alkyl group.

R²¹ to R²⁴ in the general formula (2) may be the same or different, but they are preferably the same.

Specific examples of the alkyl group represented by R²¹ to R²⁴ in the general formula (2) include a linear or branched alkyl group having 1 to 6 carbon atoms, inclusive, such as a methyl group, an ethyl group, an n-propyl group, an isopropyl group, an n-butyl group, an isobutyl group, an n-pentyl group, and an n-hexyl group.

Examples of the substituent of the alkyl group represented by R²¹ to R²⁴ in the general formula (2) include a linear or branched alkoxy group, and specific examples thereof include a methoxy group, an ethoxy group, a propoxy group, an isopropoxy group, a butoxy group, and an isobutoxy group.

In the general formula (2), R²¹ to R²⁴ are preferably an unsubstituted alkyl group, more preferably an alkyl group having 1 to 6 carbon atoms, inclusive, more preferably an alkyl group having 1 to 4 carbon atoms, inclusive, and still more preferably an alkyl group having 1 to 3 carbon atoms, inclusive, from a viewpoint of having more excellent cleaning properties and further inhibiting generation of cracks.

The tetraalkoxysilane preferably includes a tetraalkoxysilane having an alkoxy group having 1 to 6 carbon atoms, inclusive, more preferably includes a tetraalkoxysilane having an alkoxy group having 1 to 4 carbon atoms, inclusive, and still more preferably includes a tetraalkoxysilane having an alkoxy group having 1 to 3 carbon atoms, inclusive.

With the tetraalkoxysilane having 1 to 6 carbon atoms, the half width of the diffraction peak derived from silicon dioxide obtained by a powder X-ray diffraction method is more likely to be adjusted to 5° or more, and an amorphous form is more likely to be formed.

A method for forming the inorganic layer or the silica glass layer is not limited. For example, the inorganic layer and the silica glass layer may be formed by applying a composition for forming a layer onto a conductive base material through spray coating or the like, and then heating the coating film.

The average thicknesses of the inorganic layer or the silica glass layer is, for example, preferably 10 nm or more and 100 μm or less, more preferably 10 nm or more and 50 μm or less, and still more preferably 50 nm or more and 10 μm or less.

The inorganic layer and the silica glass layer may contain other additives as necessary as long as the effects of the exemplary embodiment are not impaired. Examples of the additive include the same additives as the other additives in the elastic layer described later.

(Conductive Base Material)

The conductive member according to the exemplary embodiment includes a conductive base material.

Examples of the conductive base material to be used include: metals or alloys such as aluminum, copper alloys, and stainless steel; iron plated with chromium, nickel, or the like; a material made of a conductive material such as a conductive resin (e.g., a resin base material containing a conductive material or a rubber base material containing a conductive material).

The conductive base material functions as an electrode and a support member, and examples of the material of the conductive base material include metals such as iron (e.g., free-cutting steel), copper, brass, stainless steel, aluminum, and nickel. Examples of the conductive base material also include a member whose outer peripheral surface is plated (resin member, ceramic member, etc.), and a member in which a conductive agent is dispersed (rubber member, resin member, ceramic member, etc.). The conductive base material may also be a hollow member (tube-shaped member) or a non-hollow member.

The outer diameter of the conductive base material is not limited and may be appropriately selected depending on the application. Examples thereof include the range of 3 mm or more and 10 mm or less.

The length of the conductive base material in the axial direction is not limited and may be appropriately selected depending on the application. Examples thereof include the range of 220 mm or more and 380 mm or less.

(Elastic Layer)

The conductive member of the exemplary embodiment may further includes an elastic layer between the conductive base material and the inorganic layer or the silica glass layer. The elastic layer may be either one or more than one layer..

The elastic layer contains an elastic material.

Examples of the elastic material include a rubber material and a resin material. Examples of the rubber material include isoprene rubber, chloroprene rubber, epichlorohydrin rubber, butyl rubber, silicone rubber, fluororubber, styrene-butadiene rubber, butadiene rubber, nitrile rubber, ethylene propylene rubber, epichlorohydrin-ethylene oxide copolymer rubber, epichlorohydrin-ethylene oxide-allyl glycidyl ether ternary copolymer rubber, ethylene-propylene-diene ternary copolymer rubber (EPDM), acrylonitrile-butadiene copolymer rubber (NBR), natural rubber, and a rubber obtained by mixing these rubbers.

Examples of the resin material include a polyurethane resin, a polyimide resin (PI resin), a polyamide imide resin (PAI resin), an aromatic polyether ketone resin (for example, aromatic polyether ether ketone resin), a polyphenylene sulfide resin (PPS resin), a polyether imide resin (PEI resin), a polyester resin, a polyamide resin, and a polycarbonate resin.

From a viewpoint of conductivity control, the elastic layer may contain a conductive agent such as an electronic conductive agent or an ionic conductive agent.

Examples of the electronic conductive agent include fine particles of: carbon black such as Ketjenblack and acetylene black; pyrocarbon and graphite; metals and alloys such as aluminum, copper, nickel, and stainless steel; conductive metal oxides such as tin oxide, indium oxide, titanium oxide, tin oxide-antimony oxide solid solution, and tin oxide-indium oxide solid solution; and insulating materials having surfaces treated to exhibit conductivity.

The electronic conductive agents may be used alone or in combination.

Examples of the ionic conductive agent include quaternary ammonium salts (e.g., perchlorate salts, chlorate salts, hydrofluoboric acid salts, sulfate salts, ethosulfate salts, benzyl bromide salts, or benzyl chloride salts of alkyltrimethylammonium perchlorate, lauryltrimethylammonium, stearyltrimethylammonium, octadecyltrimethylammonium, dodecyltrimethylammonium, hexadecyltrimethylammonium, or modified fatty acid-dimethylethylammonium), aliphatic sulfonates, higher alcohol sulfuric acid ester salts, higher alcohol ethylene oxide-added sulfuric acid ester salts, higher alcohol phosphoric acid ester salts, higher alcohol ethylene oxide-added phosphoric acid ester salts, betaines, higher alcohol ethylene oxides, polyethylene glycol fatty acid esters, and polyhydric alcohol fatty acid esters.

The ionic conductive agent may be a polymer material having ion conductivity, such as an epichlorohydrin rubber, an epichlorohydrin-ethylene oxide copolymer rubber, or an epichlorohydrin-ethylene oxide-allyl glycidyl ether ternary copolymer rubber.

The ionic conductive agent may be a compound in which an ionic conductive agent is bonded to a terminal of a polymer material such as resin.

The ionic conductive agents may be used alone or in combination of two or more thereof.

Examples of other additives include known materials that may be added to an elastic body, such as a softener, a plasticizer, a curing agent, a vulcanizing agent, a vulcanization accelerator, an antioxidant, a surfactant, a coupling agent, and a filler (silica, calcium carbonate, etc.).

The elastic layer may be a foam containing an elastic material (hereinafter, also referred to as an “elastic foam”). A foaming agent, a foam stabilizer, a catalyst, and the like may be used as necessary to obtain the elastic foam. Examples of the foaming agent include: water; azo compounds such as azodicarbonamide, azobisisobutyronitrile, and diazoaminobenzene; benzenesulfonyl hydrazides such as benzenesulfonyl hydrazide, 4,4′-oxybisbenzenesulfonyl hydrazide, and toluenesulfonyl hydrazide; bicarbonates such as sodium hydrogen carbonate that generate carbon dioxide gas through thermal decomposition; mixtures of NaNO₂ and NH₄Cl that generate nitrogen gas; and peroxides that generate oxygen.

—Formation of Elastic Layer—

A method for forming the elastic layer is not limited, and a known method is used.

In the case of an elastic foam, examples of the method include a method including preparing a composition containing an elastic material, a foaming agent, and other components (e.g., a vulcanizing agent), extruding the composition into a cylindrical shape, and then heating the molded product to cause vulcanization and foaming, and a method including cutting a huge foam into a cylindrical shape. Alternatively, a cylindrical elastic foam may be obtained by forming a columnar elastic foam and then forming a center hole for inserting a support member. After the cylindrical elastic foam is obtained, the shape may be further adjusted, or post-treatment such as polishing of the surface may be performed as necessary.

—Volume Resistance Value of Elastic Layer—

The elastic layer preferably has a volume resistance value of 10⁵Ω or less, more preferably 10¹Ω or more and 10⁵Ω or less, and still more preferably 10²Ω or more and 10⁴Ω or less when a voltage of 10 V is applied.

The volume resistance value of the elastic layer is measured as follows.

The conductive member is placed on a metal plate such as a copper plate with application of a load of each 500 g to both ends of the conductive member, a voltage (V) of 10 V (in the case of an elastic layer) is applied between a conductive support member of the conductive member and the metal plate by using a minute current measuring device (R8320 manufactured by Advantest Corporation), a current value I (A) after 5 seconds is read, and calculation is performed using the following equation. The measurement is performed at a temperature of 22° C. and a humidity of 55% RH.

volume resistance value Rv(Ω)=V/I Equation:

—Thickness of Elastic Layer—

The thickness of the elastic layer is not limited and may be appropriately selected according to the application. For example, when the conductive member according to the exemplary embodiment is used for a transfer member, the thickness of the elastic layer is preferably 2 mm or more and 20 mm or less, and more preferably 2 mm or more and 15 mm or less.

The outer diameter of the elastic layer is not limited and may be appropriately selected depending on the application, and is, for example, in the range of 6 mm or more and 30 mm or less.

The length of the elastic layer in the axial direction is not limited and may be appropriately selected depending on the application, and is, for example, in the range of 220 mm or more and 380 mm or less.

(Conductive Coating Layer)

The elastic layer may include a conductive coating layer that covers an exposed surface of the elastic layer.

The exposed surface of the elastic layer refers to a region of the elastic layer that is not in contact with the conductive base material or other layers and is exposed when viewed from the entire conductive member.

The exposed surface of the elastic layer may be entirely or partially covered with a conductive coating layer.

A method for forming the conductive coating layer is not limited. Examples of the method include a method including applying a treatment liquid containing a conductive agent, a resin, water, and the like to an elastic foam and heating and drying the conductive material to which the treatment liquid is attached.

Examples of the method for applying the treatment liquid include a method of applying the treatment liquid to the elastic foam by spray coating or the like and a method of immersing the elastic foam in the treatment liquid. The treatment liquid permeates into the surface of the elastic layer and the inside of bubbles through these methods.

Examples of the conductive agent include an electronic conductive agent and an ionic conductive agent. Among these conductive agents, an electronic conductive agent is preferable. For the conductive agent, one type may be used, or two or more types may be used.

Examples of the electronic conductive agent include the same ones as the electronic conductive agent contained in the elastic layer described above, and preferred aspects thereof are also the same.

The resin is not limited as long as it is capable of forming a coating layer on the exposed surface of the elastic layer, and examples thereof include an acrylic resin, a urethane resin, a fluorine resin, and a silicone resin. As the resin, one type may be used, or two or more types may be used.

The resin may be used as a latex.

Examples of the latex include natural rubber latex, butadiene rubber latex, acrylonitrile-butadiene rubber latex, acrylic rubber latex, polyurethane rubber latex, fluororubber latex, and silicone rubber latex, in addition to the latex of the above-described resin.

The concentrations of the conductive agent and the resin in the treatment liquid may be appropriately designed according to the formability of the conductive coating layer, the resistance value required for the elastic layer, and the like.

(Intermediate Layer)

The conductive member of the exemplary embodiment may further include an intermediate layer between the conductive base material and the inorganic layer or the silica glass layer.

The intermediate layer preferably contains a conductive agent from a viewpoint of adjusting the resistance of the conductive member.

Both an electronic conductive agent and an ionic conductive agent may be used as the conductive agent, but an ionic conductive agent is preferably used from a viewpoint of improving charge maintaining properties. Examples of the ionic conductive agent include the same ones as the ionic conductive agent contained in the elastic foam, and preferred aspects thereof are also the same. The ionic conductive agents may be used alone or in combination of two or more thereof.

The intermediate layer may contain a binder material in addition to the ionic conductive agent.

The binder material is not limited, and examples thereof include a resin and an elastic material that can form the intermediate layer. Examples of the resin used for the intermediate layer include a urethane resin, an acrylic resin, an epoxy resin, and a silicone resin. Examples of the elastic material contained in the intermediate layer include the same ones as the elastic material used for the elastic layer.

When the intermediate layer contains a binder material, the content of the ionic conductive agent is preferably 0.1 part by mass or more and 5.0 parts by mass or less and more preferably 0.5 parts by mass or more and 3.0 parts by mass or less relative to 100 parts by mass of the binder material.

The intermediate layer may contain other additives depending on the physical properties required for the intermediate layer.

The volume resistance value of the intermediate layer at the time of applying a voltage of 100 V is preferably 10⁴Ω or more and 10⁹Ω or less (more preferably 10⁶Ω or more and 10⁹Ω or less).

A method for forming the intermediate layer is not limited, and a known method may be applied. Examples of the method for forming the intermediate layer include a method including applying a coating liquid for forming an intermediate layer to the elastic layer and drying the coating film.

The thickness of the intermediate layer may be determined according to an application of the conductive member, but is preferably, for example, thinner than the elastic layer. When the conductive member according to the exemplary embodiment is a secondary transfer roller, the intermediate layer is, for example, 0.5 mm or more and 5 mm or less.

(Application)

The conductive member according to the exemplary embodiment is used as a member for an electrophotographic image forming apparatus (e.g. a transfer member that transfers a toner image onto a recording medium or an intermediate transfer body, a recording medium transport member, or an intermediate transfer body). The conductive member according to the exemplary embodiment may be used as a member for an apparatus other than an electrophotographic image forming apparatus (e.g. a charging member that charges a charge receiving body, or a transfer member that transfers an object to be transferred to a transfer receiving body).

<Image Forming Apparatus, Charging Device, Transfer Device, Process Cartridge>

An image forming apparatus according to an exemplary embodiment includes an image holding member, a charging device that charges the surface of the image holding member, an electrostatic latent image forming device that forms an electrostatic latent image on the charged surface of the image holding member, a developing device that develops the electrostatic latent image formed on the surface of the image holding member by using a developer containing toner to form a toner image, and a transfer device that transfers the toner image onto a surface of a recording medium.

As the transfer device, a transfer device (the transfer device according to the exemplary embodiment) including the conductive member according to the exemplary embodiment as a transfer member that contacts a recording medium (an example of the transfer receiving body) to transfer a toner image (an example of the object to be transferred) to the recording medium is applied.

A process cartridge according to the exemplary embodiment is, for example, detachably attached to the image forming apparatus having the above configuration, the process cartridge including a transfer device that transfers a toner image onto a surface of a recording medium. The above-described transfer device according to the exemplary embodiment is employed as the transfer device.

The process cartridge according to the exemplary embodiment may include at least one selected from the group consisting of, for example, an image holding member, an electrostatic latent image forming device that forms an electrostatic latent image on the charged surface of the image holding member, a developing device that develops the latent image formed on the surface of the image holding member by using toner to form a toner image, a transfer device that transfers the toner image formed on the surface of the image holding member onto a recording medium, and a cleaning device that cleans the surface of the image holding member, as necessary.

Next, the image forming apparatus and process cartridge according to the exemplary embodiment will be described with reference to the drawings.

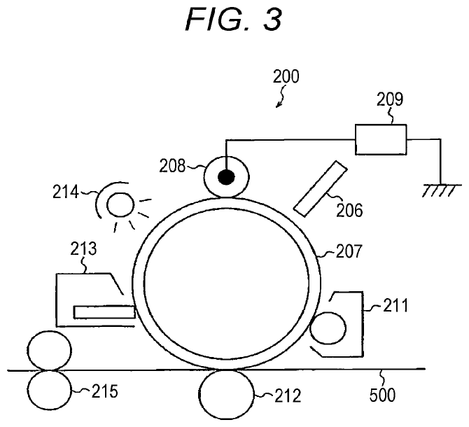

FIG. 3 is a schematic configuration diagram illustrating a direct transfer-type image forming apparatus as an example of the image forming apparatus according to the exemplary embodiment.

An image forming apparatus 200 illustrated in FIG. 3 includes a photoreceptor 207 (an example of the image holding member), a charging roller 208 (an example of the charging unit) that charges the surface of the photoreceptor 207, an exposure device 206 (an example of the electrostatic charge image forming unit) that forms an electrostatic charge image on the charged surface of the photoreceptor 207, a developing device 211 (an example of the developing unit) that develops, as a toner image, the electrostatic charge image formed on the surface of the photoreceptor 207 by using a developer containing toner, and a transfer roller 212 (an example of the transfer unit, an example of the transfer device according to the exemplary embodiment) that transfers the toner image formed on the surface of the photoreceptor 207 onto a surface of a recording medium.

The conductive member according to the exemplary embodiment is applied to the transfer roller 212 that presses its outer peripheral surface against the photoreceptor 207 corresponding to a counter roller to form an insertion part through which a recording paper 500 is to be inserted.

The image forming apparatus 200 illustrated in FIG. 3 further includes a cleaning device 213 that removes toner remaining on the surface of the photoreceptor 207, a charge eliminating device 214 that removes the charges on the surface of the photoreceptor 207, and a fixing device 215 (an example of a fixing unit) that fixes the toner image on a recording medium.

The charging roller 208 may be of a contact charging type or a non-contact charging type. A voltage is applied to the charging roller 208 from a power supply 209.

Examples of the exposure device 206 include an optical device including a light source such as a semiconductor laser or a light emitting diode (LED).

The developing device 211 is a device that supplies toner to the photoreceptor 207. For example, the developing device 211 forms a toner image by bringing a roll-shaped developer holding member into contact with or close to the photoreceptor 207 and attaching toner to an electrostatic charge image on the photoreceptor 207.

The transfer roller 212 is a transfer roller that is in direct contact with the surface of the recording medium, and is disposed at a position facing the photoreceptor 207. The recording paper 500 (an example of the recording medium) is supplied to a gap between the transfer roller 212 and the photoreceptor 207 in contact with each other through a supply mechanism. When a transfer bias is applied to the transfer roller 212, electrostatic force from the photoreceptor 207 toward the recording paper 500 acts on the toner image, and the toner image on the photoreceptor 207 is transferred onto the recording paper 500.

The fixing device 215 may be, for example, a heat-fixing device including a heating roller and a pressing roller that presses the heating roller.

Examples of the cleaning device 213 include a device including a blade, a brush, a roller, and the like as a cleaning member.

The charge eliminating device 214 is, for example, a device that eliminates residual potential on the photoreceptor 207 by irradiating the surface of the photoreceptor 207 after transfer with light.

The photoreceptor 207 and the transfer roller 212 may have a cartridge structure (process cartridge according to the exemplary embodiment) that is integrated by, for example, one housing and is detachably attached to an image forming apparatus. The cartridge structure (process cartridge according to the exemplary embodiment) may further include at least one selected from the group consisting of the charging roller 208, the exposure device 206, the developing device 211, and the cleaning device 213.

The image forming apparatus may be a tandem-type image forming apparatus in which a plurality of image forming units are mounted side by side, each of the unit including the photoreceptor 207, the charging roller 208, the exposure device 206, the developing device 211, the transfer roller 212, and the cleaning device 213.

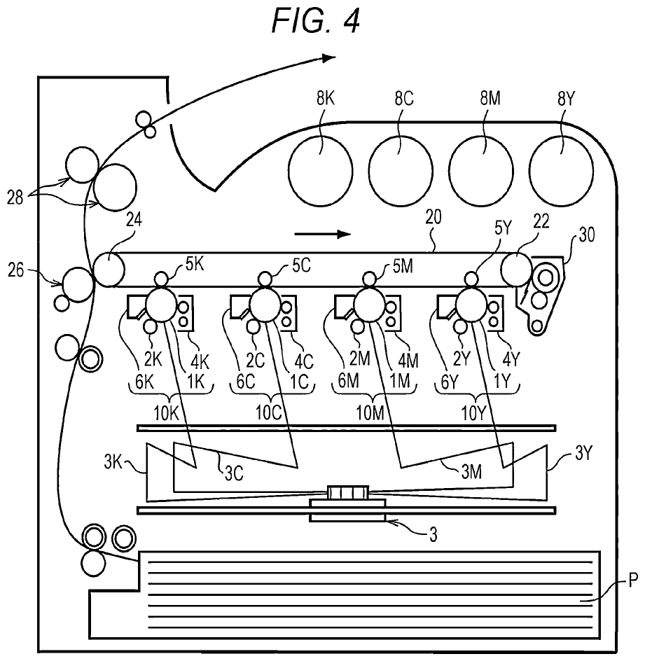

FIG. 4 is a schematic configuration diagram illustrating an intermediate transfer type image forming apparatus, which is an example of the image forming apparatus according to the exemplary embodiment. The image forming apparatus illustrated in FIG. 4 is a tandem-type image forming apparatus in which four image forming units are disposed in parallel.

In the image forming apparatus illustrated in FIG. 4, the transfer unit that transfers the toner image formed on the surface of the image holding member onto a surface of a recording medium is configured as a transfer unit (an example of the transfer device according to the exemplary embodiment) including an intermediate transfer body, a primary transfer unit, and a secondary transfer unit. The transfer unit may have a cartridge structure detachably attached to an image forming apparatus.

The image forming apparatus illustrated in FIG. 4 includes a photoreceptor 1 (an example of the image holding member), a charging roller 2 (an example of the charging unit) that charges the surface of the photoreceptor 1, an exposure device 3 (an example of the electrostatic charge image forming unit) that forms an electrostatic charge image on the charged surface of the photoreceptor 1, a developing device 4 (an example of the developing unit) that develops, as a toner image, the electrostatic charge image formed on the surface of the photoreceptor 1 by using a developer containing toner, an intermediate transfer belt 20 (an example of the intermediate transfer body), a primary transfer roller 5 (an example of the primary transfer unit) that transfers the toner image formed on the surface of the photoreceptor 1 to a surface of the intermediate transfer belt 20, and a secondary transfer roller 26 (an example of the secondary transfer unit) that transfers the toner image transferred onto the surface of the intermediate transfer belt 20 onto a surface of a recording medium.

The conductive member according to the exemplary embodiment is applied to the secondary transfer roller 26 that presses its outer peripheral surface against the support roller 27 corresponding to a counter roller to form an insertion part through which a recording paper P is to be inserted.

The image forming apparatus illustrated in FIG. 4 further includes a fixing device 28 (an example of a fixing unit) that fixes the toner image on the recording medium, a photoreceptor cleaning device 6 that removes toner remaining on the surface of the photoreceptor 1, and an intermediate transfer belt cleaning device 30 that removes toner remaining on the surface of the intermediate transfer belt 20.

The image forming apparatus illustrated in FIG. 4 includes first to fourth electrophotographic image forming units 10Y, 10M, 10C, and 10K that respectively output yellow (Y), magenta (M), cyan (C), and black (K) color images based on color-separated image data. The image forming units 10Y, 10M, 10C, and 10K are arranged apart from each other in a horizontal direction. Each of the image forming units 10Y, 10M, 10C, and 10K may be a process cartridge detachably attached to an image forming apparatus.

The intermediate transfer belt 20 is disposed above the image forming units 10Y, 10M, 10C, and 10K to extend through each image forming unit. The intermediate transfer belt 20 is wound around a drive roller 22 and a support roller 24 that are disposed in contact with the inner surface of the intermediate transfer belt 20 and runs in the direction from the first image forming unit 10Y toward the fourth image forming unit 10K. A force is applied to the support roller 24 in a direction away from the drive roller 22 with a spring or the like (not illustrated), so that a tension is applied to the intermediate transfer belt 20 wound around the support roller and the drive roller. On the image holding surface side of the intermediate transfer belt 20, an intermediate transfer belt cleaning device 30 is provided facing the drive roller 22.

Developing devices 4Y, 4M, 4C, and 4K of the image forming units 10Y, 10M, 10C, and 10K are respectively supplied with yellow, magenta, cyan, and black toners contained in the toner cartridges 8Y, 8M, 8C, and 8K.

Since the first to fourth image forming units 10Y, 10M, 10C, and 10K have the same configuration and operation, the first image forming unit 10Y will be described as a representative example when the image forming units are described hereinafter.

The first image forming unit 10Y includes a photoreceptor 1Y, a charging roller 2Y that charges the surface of the photoreceptor 1Y, a developing device 4Y that develops, as a toner image, an electrostatic charge image formed on the surface of the photoreceptor 1Y by using a developer containing toner, a primary transfer roller 5Y that transfers the toner image formed on the surface of the photoreceptor 1Y onto a surface of the intermediate transfer belt 20, and a photoreceptor cleaning device 6Y that removes toner remaining on the surface of the photoreceptor 1Y after the primary transfer.

The charging roller 2Y charges the surface of the photoreceptor 1Y. The charging roller 2Y may be of contact charging type or a non-contact charging type.

The charged surface of the photoreceptor 1Y is irradiated with a laser beam 3Y from the exposure device 3. This causes an electrostatic charge image with a yellow image pattern to form on the surface of the photoreceptor 1Y.

The developing device 4Y contains, for example, an electrostatic charge image developer containing at least yellow toner and a carrier. The yellow toner is frictionally charged by being stirred in the developing device 4Y. As the surface of the photoreceptor 1Y passes through the developing device 4Y, the electrostatic charge image formed on the photoreceptor 1Y is developed as a toner image.

The primary transfer roller 5Y is disposed on the inner side of the intermediate transfer belt 20 to face the photoreceptor 1Y. A bias power supply (not illustrated) that applies a primary transfer bias is connected to the primary transfer roller 5Y. The primary transfer roller 5Y transfers the toner image on the photoreceptor 1Y onto the intermediate transfer belt 20 with electrostatic force.

Toner images of the respective colors are multiply transferred onto the intermediate transfer belt 20 in order from the first to fourth image forming units 10Y, 10M, 10C, and 10K. The intermediate transfer belt 20 on which the toner images of the four colors have been multiply transferred through the first to fourth image forming units reaches the secondary transfer unit including the support roller 24 and the secondary transfer roller 26.

The secondary transfer roller 26 is a transfer roller that directly contacts a surface of a recording medium and is disposed at a position facing the support roller 24 on the outer side of the intermediate transfer belt 20. The recording paper P (an example of the recording medium) is supplied to a gap between the secondary transfer roller 26 and the intermediate transfer belt 20 through a supply mechanism. When a secondary transfer bias is applied to the secondary transfer roller 26, electrostatic force in a direction from the intermediate transfer belt 20 to the recording paper P acts on the toner image, and the toner image on the intermediate transfer belt 20 is transferred onto the recording paper P.

The recording paper P on which the toner image has been transferred is sent to a pressure contact part (nip part) of the fixing device 28 including a pair of rollers, and the toner image is fixed on the recording paper P.

The intermediate transfer belt 20, the primary transfer roller 5, and the secondary transfer roller 26 correspond to an example of the transfer device.

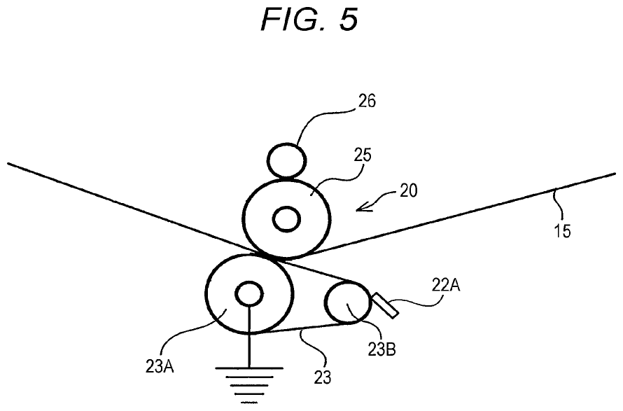

The image forming apparatus 200 may include a secondary transfer belt (an example of a secondary transfer member) instead of the secondary transfer roller 26. Specifically, as illustrated in FIG. 5, the image forming apparatus 200 may include a secondary transfer apparatus including a secondary transfer belt 23, a drive roller 23A disposed to face a back roller 25 with an intermediate transfer belt 15 and the secondary transfer belt 23 interposed therebetween, and an idler roller 23B that stretches the secondary transfer belt 23 together with the drive roller 23A.

The toner and developer used in the image forming apparatus according to the exemplary embodiment are not limited, and any known electrophotographic toner and developer may be used.

The recording medium used in the image forming apparatus according to the exemplary embodiment is not limited, and examples thereof include paper used in electrophotographic copying machines and printer, and OHP sheets.

### EXAMPLES

Hereinafter, the present invention will be described more specifically with reference to Examples. These Examples do not limit the present invention. In the description, “part” and “%” are based on mass unless otherwise specified.

### Example 1

### [Formation of Elastic Layer]

(Formation of Elastic Foam)

EP70 (manufactured by INOAC CORPORATION) was used as an elastic foam and cut into a cylindrical shape having an outer diameter of 26 mm and an inner diameter of 14 mm, whereby a cylindrical elastic foam was obtained.

The obtained elastic foam had an open-cell structure, whose cell diameter was 400 μm, and the density was 70 kg/m³.

(Formation of Conductive Coating Layer)

The elastic foam obtained by the above method was immersed in a treatment liquid prepared by mixing an aqueous dispersion containing 36 mass % of carbon black dispersed therein with an acrylic emulsion (product name “Nipol LX852”, manufactured from Zeon Corporation) at a weight ratio of 1:1 at 20° C. for 10 minutes. Thereafter, the elastic foam to which the treatment liquid was attached was heated and dried in a curing furnace set at 100° C. for 60 minutes to remove moisture and form crosslink of the acrylic resin. A conductive coating layer containing carbon black was formed on an exposed surface of the elastic foam with the acrylic resin cured by crosslinking. An elastic layer including an elastic foam and a conductive coating layer that covers an exposed surface of the elastic foam was thus obtained.

Next, a conductive support member (made of SUS, diameter: 14 mm) with an adhesive on its surface was inserted into the obtained elastic layer to form a roller member.

[Formation of Intermediate Layer]

A coating liquid for forming an intermediate layer was obtained by mixing 70 parts of a urethane oligomer (urethane acrylate UV 3700B manufactured by Nippon Synthetic Chemical Industry Co., Ltd.), 30 parts of a urethane monomer (isomyristyl acrylate manufactured by Kyoeisha Chemical Co., Ltd.), 0.5 parts of a polymerization initiator (1-hydroxycyclohexyl phenyl ketone Irgacure 184 manufactured by Ciba Specialty Chemicals K. K.), and 3 parts of alkyltrimethylammonium perchlorate (product name “LXN-30” manufactured by Daiso Chemical Co., Ltd.). The obtained coating liquid for forming an intermediate layer was applied onto the elastic layer of the above-described roller member using a die coater, and the coating film was subjected to UV irradiation for 5 seconds at a UV irradiation intensity of 700 mW/cm² while being rotated. In this operation, an intermediate layer having a thickness of 1 mm was formed.

[Formation of Surface Layer]

Subsequently, a treatment liquid (SV2000, manufactured by Nano Glass Coat Japan Co., Ltd.) containing tetraethoxysilane was spray-coated on the intermediate layer, and the coating film was dried and cured at 80° C. for 120 minutes, whereby a surface layer having a thickness of 0.1 μm was formed.

A conductive member that was a conductive roller having a volume resistance value of 10⁶⁸Ω (measured value when 1000 V was applied) was thus obtained.

### Example 2

A conductive member was obtained in the same manner as in Example 1 except that the coating film was dried and cured at 80° C. for 360 minutes in the formation of the surface layer.

### Example 3

A conductive member was obtained in the same manner as in Example 1 except that the coating film was dried and cured at 120° C. for 120 minutes in the formation of the surface layer.

### Comparative Examples 1 and 2

Conductive members were obtained in the same manner as in Example 1 except that the material for forming the outermost surface layer was set as specified in Table 1.

### Comparative Example 3

A conductive member was obtained in the same manner as in Example 1 except that the material for forming the outermost surface layer was a mixed solution of 100 parts of a xylene solution containing 20 mass % of perhydropolysilazane and 2.2 parts of n-hexyl alcohol.

### Example B1

### [Formation of Conductive Base Material]

A cylindrical conductive base material was obtained by applying a coating liquid for forming a base material layer (solid content concentration: 18 mass %) containing a polyamic acid and carbon black onto a cylindrical mold and firing the obtained coating film at 380° C.

[Formation of Elastic Layer]

A dispersion (hereinafter, also referred to as “CB20 part dispersion”) was prepared by mixing butyl acetate and DENKA BLACK Li (manufactured by Denki Kagaku Kogyo Kabushiki Kaisha) in 20 parts by weight. The obtained dispersion was subjected to a high-pressure dispersion treatment (conditions: liquid temperature: 45° C., 50 MPa, three cycles (that is, the number of times of passing through the valve (the number of passing): three times) with a high-pressure homogenizer (HC3 manufactured by Sanmaru Machinery Co., Ltd.).

Subsequently, 50 parts by mass of a silicone rubber stock solution (X-34-1053A and B manufactured by Shin-Etsu Chemical Co., Ltd. weighed in the same amount, concentration of solid content: 100 mass %) was added to 50 parts by mass of the dispersion liquid after the high-pressure dispersion treatment to prepare a precursor liquid. The obtained precursor liquid was stirred in a planetary mixer (ACM-SLUT manufactured by AICOHSHA MFG. Co., LTD.) under the conditions of a liquid temperature of 30° C. and vacuuming for 10 minutes to obtain a coating liquid for forming an elastic layer.

Next, the obtained coating liquid for forming an elastic layer was applied onto the base material layer to form a coating film, and the coating film was heated at 100° C. for 30 minutes, whereby an elastic layer having a film thickness of 450 μm was formed.

[Formation of Outermost Surface Layer]

An outermost surface layer was formed in the same manner as in Example 1 except that the material for forming the outermost surface layer was set as specified in Table 1.

A conductive member was thus obtained as a belt having a volume resistance value of 10⁸Ω (measured value when 1000 V was applied).

### Example B2

A belt was produced in the same manner as in Example 1 except that the coating film was dried and cured at 80° C. for 360 minutes in the formation of the surface layer.

### Example B3

A belt was obtained in the same manner as in Example 1 except that the coating film was dried and cured at 120° C. for 120 in the formation of the surface layer.

In Table 1, the part described as “—” in the item “Carbon number of tetraalkoxysilane” indicates the case where a tetraalkoxysilane is not used for layer formation.

In Table 1, the part described as “—” in the item “Half width of diffraction peak derived from silicon dioxide” indicates a layer having no diffraction peak derived from silicon dioxide.

In Table 1, the half width of the diffraction peak derived from polysilazane is described as a reference in Comparative Example 3 and Comparative Example B3, and the outermost surface layers of Comparative Example 3 and Comparative Example B3 do not have a diffraction peak derived from silicon dioxide. Because the polysilazane used in Comparative Example 3 and Comparative Example B3 is a prepared product, “—” was added to the item “Material” for putting a product number of a commercial product.

<Evaluation>

—Evaluation of Friction Coefficient—

For the conductive member of each example, a sheet having a thickness of 1 mm was cut out from the outermost layer in the stacking direction, and the cut sheet was used as a test piece. The friction coefficient of the test piece relative to a urethane block was measured in an environment of a temperature of 22° C. and a humidity of 55% using a Heidon friction coefficient measuring machine (manufactured by Heidon). The obtained friction coefficient values are shown in Table 1.

—Evaluation of Back Surface Stain of Passed Paper—

The conductive member of each example was mounted on ApeosPort VII C6688 manufactured by Fuji Xerox Co., Ltd., a K100% solid image was output onto 10,000 sheets of A3 plain paper on one side, the back surface stain of the 10,001 th output paper was visually checked, and the back surface stain of the passed paper was evaluated according to the following criteria. The results are shown in Table 1.

G1: No stains are generated on the back surface.

G2: Although stains were thinly observed on the back surface, the stains were within an allowable range.

G3: A streak-like image defect was observed on the back surface.

G4: A dark streak-like image defect was observed on the back surface.

—Evaluation of Cracks after Passing of Paper—

After passing paper, the conductive member was taken out from the image forming apparatus, and the state of generation of cracks in the outermost surface layer was observed with a microscope and evaluated according to the following criteria. The results are shown in Table 1.

G1: No crack is generated in the entire outermost surface layer.

G2: A small crack is generated in a part of the outermost surface layer, but it was within an allowable range.

G3: A large crack is generated in a part of the outermost surface layer.

G4: Cracks are generated in a plurality of regions of the outermost surface layer.

TABLE 1

| | Outermost surface layer | | | | Evaluation | | |
|---|---|---|---|---|---|---|---|
| | | | | Half width of | | Back | |
| | | | Carbon | diffraction peak | | surface | |
| | | | number of | derived from | | stain of | Crack after |
| | | | tetraalkoxy | silicon dioxide | Friction | passed | passing of |
| | Material | Layer type | silane | [°] | coefficient | paper | paper |
| Example 1 | SV2000 | Silica glass layer | 2 | 15 | 0.10 | G1 | G1 |
| Example 2 | SV2000 | Silica glass layer | 2 | 10 | 0.10 | G1 | G1 |
| Example 3 | SV2000 | Silica glass layer | 2 | 5 | 0.10 | G1 | G2 |
| Comparative | KR4000G | Silicone layer | — | — | 0.50 | G4 | G3 |
| Example 1 | | | | | | | |
| Comparative | T862A | Urethane layer | — | — | 0.30 | G3 | G4 |
| Example 2 | | | | | | | |
| Comparative | — | Polysilazane layer | — | 3 | 0.12 | G4 | G4 |
| Example 3 | | | | | | | |
| Example B1 | SV2000 | Silica glass layer | 2 | 15 | 0.10 | G1 | G1 |
| Example B2 | SV2000 | Silica glass layer | 2 | 10 | 0.10 | G1 | G1 |
| Example B3 | SV2000 | Silica glass layer | 2 | 5 | 0.10 | G1 | G2 |
| Comparative | KR4000G | Silicone layer | — | — | 0.50 | G4 | G3 |
| Example B1 | | | | | | | |
| Comparative | T862A | Urethane layer | — | — | 0.30 | G3 | G4 |
| Example B2 | | | | | | | |
| Comparative | — | Polysilazane layer | — | 3 | 0.12 | G4 | G4 |
| Example B3 | | | | | | | |

As shown in the table, it was found that the conductive members of Examples had excellent cleaning properties and inhibited streak-like image defects caused by generation of cracks when they are mounted on an image forming apparatus, as compared with the conductive members of Comparative Examples.

What is claimed is:

1. A conductive member comprising:
a conductive base material; and
a silica glass layer disposed on an outermost surface on an outer peripheral surface of the conductive base material.

2. A conductive member comprising:
a conductive base material; and
an inorganic layer disposed an outermost surface on an outer peripheral surface of the conductive base material,
wherein the inorganic layer has a half width of a diffraction peak derived from silicon dioxide of 5° or more as obtained by a powder X-ray diffraction method.

3. The conductive member according to claim 1, wherein the silica glass layer or an inorganic layer has a half width of a diffraction peak derived from silicon dioxide of 5° or more and 15° or less as obtained by a powder X-ray diffraction method.

4. The conductive member according to claim 3, wherein the silica glass layer or an inorganic layer has a half width of a diffraction peak derived from silicon dioxide of 5° or more and 10° or less as obtained by a powder X-ray diffraction method.

5. The conductive member according to claim 1, wherein the silica glass layer or an inorganic layer is a layer of a reaction product of a tetraalkoxysilane.

6. The conductive member according to claim 5, wherein the tetraalkoxysilane includes a tetraalkoxysilane having an alkoxy group having 1 to 6 carbon atoms, inclusive.

7. A transfer device comprising the conductive member according to claim 1 as a transfer member that contacts a transfer receiving body to transfer an object to be transferred, to the transfer receiving body.

8. A process cartridge comprising the transfer device according to claim 7, wherein the process cartridge is detachably attached to an image forming apparatus.

9. An image forming apparatus comprising:
an image holding member;
a charging device that charges a surface of the image holding member;
an electrostatic latent image forming device that forms an electrostatic latent image on the charged surface of the image holding member;
a developing device that develops the electrostatic latent image formed on the surface of the image holding member by using a developer containing toner, to form a toner image; and
the transfer device according to claim 7 that transfers the toner image onto a surface of a recording medium.
